(19) United States
(12) Patent Application Publication
(10) Pub. No.: US 2018/0363837 A1
(43) Pub. Date: Dec. 20, 2018

(54) Portable Display Station

(71) Applicant: John Roberts, (US)

(72) Inventors: John Roberts, Washington, DC (US); Laurence Michael Sandell, Bethesda, MD (US)

(73) Assignee: John Roberts

(21) Appl. No.: 16/112,261

(22) Filed: Aug. 24, 2018

Related U.S. Application Data
(63) Continuation-in-part of application No. PCT/US17/19866, filed on Feb. 28, 2017.
(60) Provisional application No. 62/301,236, filed on Feb. 29, 2016.

(51) Int. Cl. F16M 11/04; F16M 13/00; F16M 11/10; F16M 11/24; F16M 11/28

(52) U.S. Cl. CPC F16M 11/043; F16M 13/00; F16M 2200/08; F16M 11/242; F16M 11/28; F16M 11/10

(57) ABSTRACT

A method for using a portable display station is disclosed. First, a portable display station with at least a main device support, a support arm connected to the main device support, and a base connected to the support arm may be provided. The method may include securing a first display device to the main device support and stabilizing the portable display station. The step of stabilizing the portable display station may include positioning at least a portion of the base under a weighted object.

### CROSS-REFERENCE TO RELATED APPLICATIONS

This application claims priority to International Patent Application PCT/US17/19866, filed Feb. 28, 2017, which claims priority to provisional U.S. Patent Application Ser. No. 62/301,236, filed Feb. 29, 2016, the disclosures of which are both incorporated by reference herein in their entireties.

### TECHNICAL FIELD

This application relates to portable systems and apparatuses for hands-free support of electronic display devices, such as smart phones and tablets, and other objects, as well as methods of using the same.

### BACKGROUND

Tablet computers, smart phones, and other portable electronic devices with displays are commonly used to watch movies and other digital videos; read books, articles, and materials; communicate via video chat; view photos; engage with social media; and the like. A user of the portable electronic device, however, is often required to hold the device in his hand as he uses it. This can be tiring and uncomfortable, particularly during extended uses of the device; can hinder communication in video chats; and can reduce productivity during reading or studying as it makes note-taking more difficult.

Some commercially available tablet and smartphone stands, for example, the “Gekko Stand,” (see https://www.kickstarter.com/projects/dwighthouser/gekko-stand-universal-and-adjustable-nanosuction-s) require a flat, stable surface to be placed upon or otherwise must be permanently or semi-permanently attached to furniture or other heavy fixtures. Additionally, such stands often do not permit electronic displays to be presented to a user at a desirable height and angle.

Other commercially available stands, such as “The Flexible Stand Up Cable,” (see https://www.stuffnice.com/products/curve-bendable-cable) may substantially consist of a flexible metal gooseneck, which may be repeatedly bent by a user to form a stand base and support the electronic device at a desired position. However, many configurations of such gooseneck stands may be incapable of reliably supporting an electronic device resulting from, for example imbalance caused by a desired electronic device position, an insufficient footprint of the stand base, or a lack a rigidity of the gooseneck. This may be particularly true when the object to be supported is a tablet or other larger device. Moreover, repeated bending of a gooseneck-type device may ultimately wear down the ability of the stand to adequately support the electronic device. Further, more durable or more rigid metal goosenecks may be undesirably heavy, unwieldy, or difficult for many users to easily bend into a desired shape.

Thus, there is a need for a portable, versatile, durable, and easy to use hands-free apparatus to support tablets, smart phones, and other devices. It would further be desirable if such a mobile, versatile hands-free device could be collapsible for ease of storage and transport.

It would further be desirable if such a mobile, versatile hands-free device could store additional power and provide it to its supported mobile devices.

### SUMMARY

The present disclosure provides a description of apparatuses and systems to address the perceived problems described above, as well as methods for using the same.

In one embodiment, a method for using a portable display station is provided. First, a portable display station with at least a main device support, a support arm connected to the main device support, and a base connected to the support arm may be provided. The method may include steps of securing a first display device to the main device support and stabilizing the portable display station. The step of stabilizing the portable display station may include positioning at least a portion of the base under a weighted object.

The first display device may be a tablet or a smart phone.

In some embodiments, the method may further include a step of securing a second display device to a secondary device support of the portable display station. The second device may be a smart phone.

In some embodiments, the step of positioning at least a portion of the base under a weighted object may include placing a user's body part on at least a portion of the base, sitting on at least a portion of the base with the support arm positioned between a user's legs, sitting on at least a portion of the base with the support arm positioned outside of a user's legs, and/or placing at least part of the base under an inanimate object.

In some embodiments, the method may further include a step of expanding a footprint of the base by at least partially fanning out a plurality of outriggers of the base. Such step may further include pivoting a first outrigger of the plurality of outriggers about a first axis.

In some embodiments, the method may further include a step of raising the support arm. Such step may further include articulating a joint assembly of the portable display station, the joint assembly connecting the support arm and the base.

In some embodiments, the method may further include a step of reorienting the main device support relative to a position of the support arm.

In some embodiments, the method may further include a step of articulating an arm joint of the support arm.

In some embodiments, the method may further include a step of expanding a telescoping section of the support arm.

In some embodiments, the method may further include a step of manipulating a gooseneck section of the support arm.

In some embodiments, the method may further include a step of plugging a charging wire of the portable display station into the first display device.

### BRIEF DESCRIPTION OF THE DRAWINGS

The accompanying drawings, which are incorporated into and constitute a part of this specification, illustrate several embodiments and aspects of the apparatuses and methods described herein and, together with the description, serve to explain the principles of the invention.

FIG. 1A depicts an embodiment of a portable display station, consistent with the present disclosure.

FIG. 1B depicts another embodiment of a portable display station, consistent with the present disclosure.

FIGS. 2A-2D depict an embodiment of a base for a portable display station from various perspectives and in various configurations, consistent with the present disclosure.

FIGS. 3A-3C depict another embodiment of a base for a portable display station from various perspectives and in various configurations, consistent with the present disclosure.

FIGS. 4A-4D depict side, back, cross-sectional side, and cross-sectional back views, respectively, of an embodiment of a base including a base connection element for a portable display station, consistent with the present disclosure.

FIGS. 5A-5C are side, back, and back views, respectively, of embodiments of a portable display station in a collapsed configuration, consistent with the present disclosure.

FIGS. 6A-6E are side views of embodiments of a portable display station in a various configurations, consistent with the present disclosure.

FIG. 6F is a front view of an embodiment of a portable display station in a display configuration, consistent with the present disclosure.

FIGS. 7A-7C depict another embodiment of a base for a portable display station from various perspectives and in various configurations, consistent with the present disclosure.

FIGS. 8A and 8B depict another embodiment of a base for a portable display station from a top perspective in various configurations, consistent with the present disclosure.

FIGS. 9A-9C are side, back, and perspective views, respectively, of a component of an embodiment of a portable display station, consistent with the present disclosure.

FIGS. 10A-10C are side, back, and perspective views, respectively, of a component of another embodiment of a portable display station, consistent with the present disclosure.

FIGS. 11A-11D are photos illustrating examples of stabilizing a portable display station with the user's body, consistent with the present disclosure.

FIG. 12 is a flow chart of an exemplary method of using a portable display station, consistent with the present disclosure.

FIG. 13 depicts another embodiment of a portable display station, consistent with the present disclosure.

FIGS. 14A-14F are photos illustrating examples of stabilizing a portable display station with various objects, consistent with the present disclosure.

### DETAILED DESCRIPTION

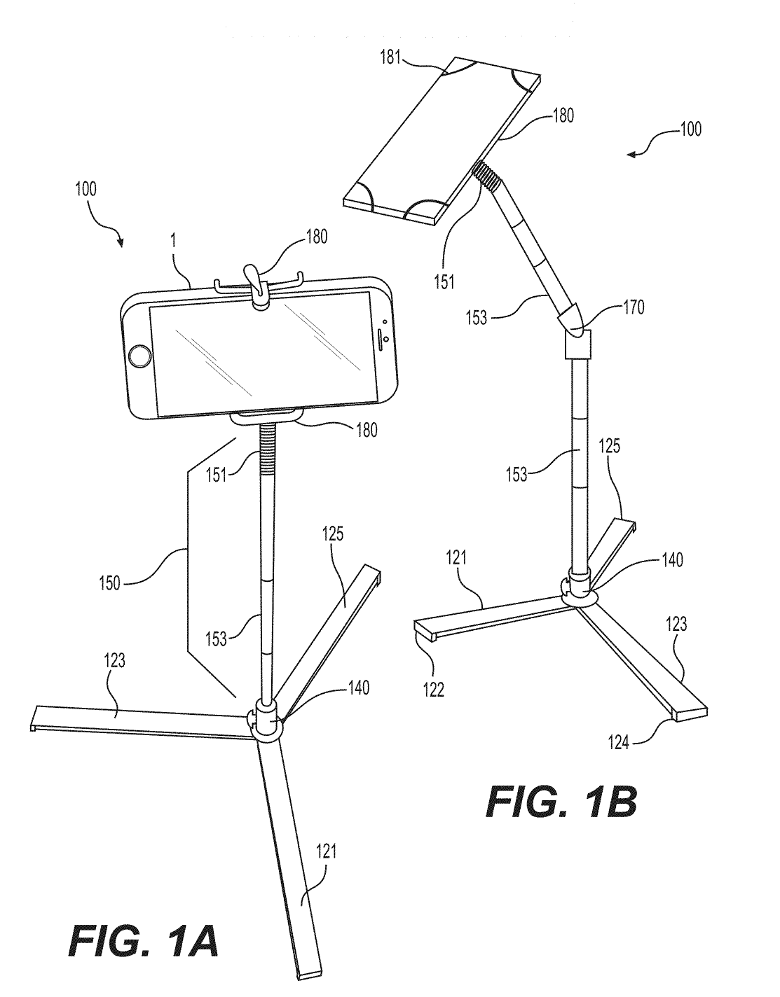

With reference to FIG. 1A, portable display station 100 may include base 120, joint assembly 140, support arm 150, and main device support 180. As shown, base 120 may include upper outrigger 121, middle outrigger 123, and bottom outrigger 125. Base 120 may be collapsible and serves to anchor portable viewing station 100. Joint assembly 140 may connect base 120 to support arm 150. Support arm 150 may connect to main device support 180, which in turn may hold a primary display device 1, such as smart phone, tablet, or another item.

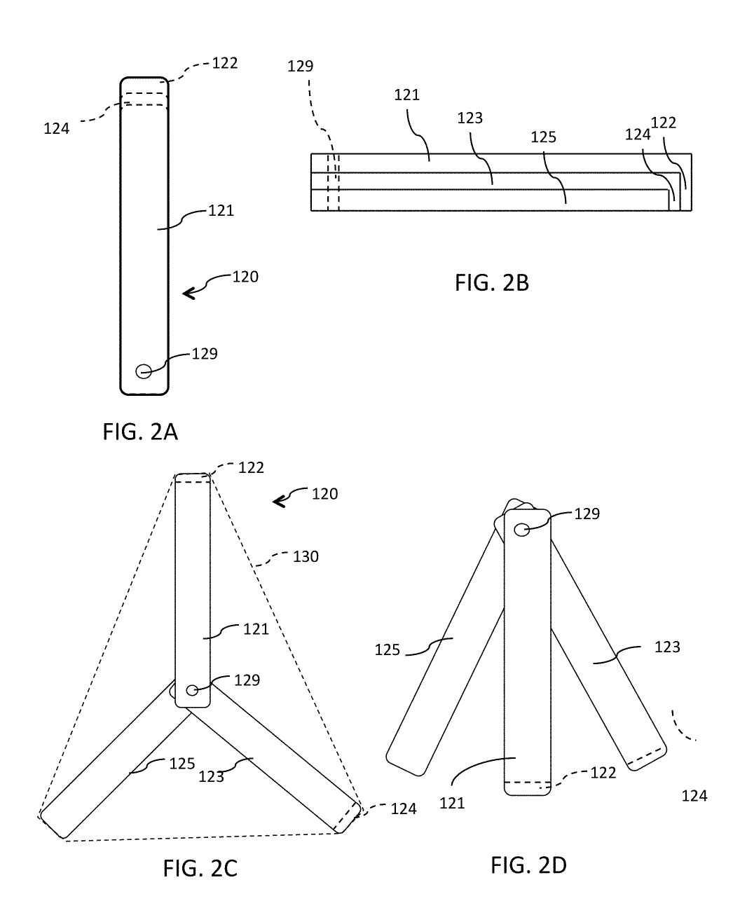

As shown in FIGS. 2A-2B, outriggers 121, 123, 125 may be collapsed when portable display station 100 is not in use. FIG. 2A depicts an example of base 120 in a collapsed configuration, and FIG. 2B is a side view of the same. In such a collapsed configuration, outriggers 121, 123, 125 may be stacked upon one another, which may minimize the footprint 130 of base 120—and therefore the size of portable display station 100, when collapsed. Base 120 may include a pivot recess 129 aligned on a first axis, about which at least outriggers 121 and 123 may pivot, for example, with respect upper outrigger 121, to enable various display configurations of base 120. In alternative embodiments, all outriggers may pivot about the first axis with respect to a component of joint assembly 140.

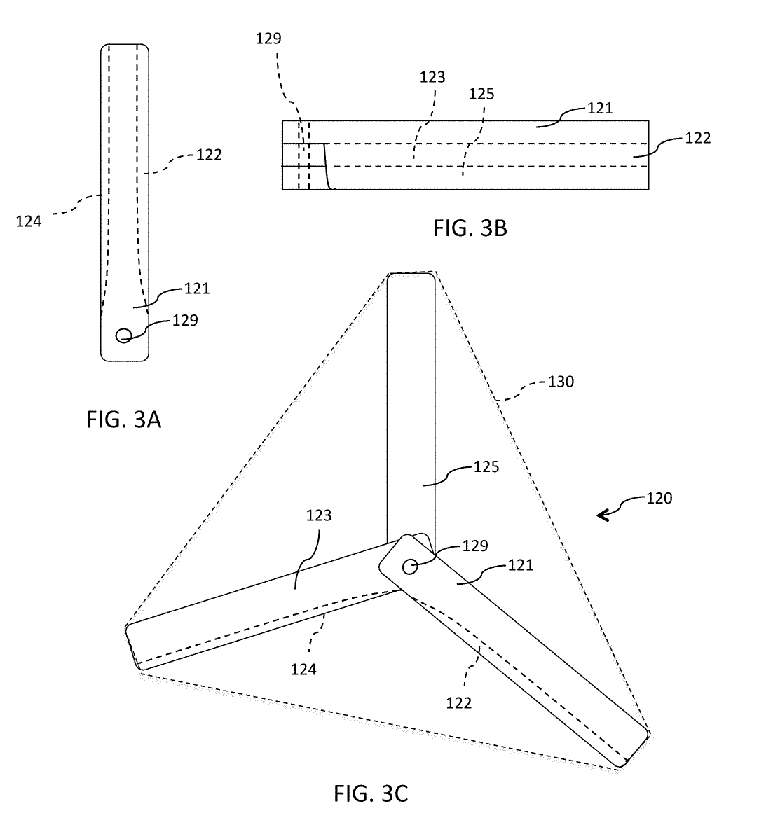

As shown in FIG. 2C, outriggers 121, 123, 125, may fan out about pivot recess 129 to enlarge footprint 130 of base 120. Such a display configuration may be desirable when, for example, portable display station 100 is to be used on the ground, on a table, or another relatively flat surface. A footprint 130 may be measured from the outermost edges of each outrigger, and may include the areas in between respective outriggers, for example as shown in FIGS. 2C and 3C. A maximum footprint may be defined as the largest footprint 130 that a given base 120 may be configured to provide. For example, with respect to the embodiment depicted in FIGS. 2A-2C, the maximum footprint may be obtained when the three outriggers are positioned 120 degrees apart from one another. A larger footprint 130 may correspond to a more stable portable display station 100.

As shown in FIG. 2D, outriggers 121, 123, 125, may partially fan out about pivot recess 129, for example, such that the angle formed by the outermost outriggers is less than 180 degrees. Such an alternative display configuration may be desirable when portable display station 100 is to be stabilized by a user sitting on a partially fanned out base 120. As illustrative examples, a user may sit directly upon a partially fanned out base 120 to stabilize portable display station when sitting on the ground; sitting on a chair or couch; or sitting in a bus, train, car, or plane seat. Advantageously, a user may sit on base 120 with support arm 150 located in between or on the outside of his legs, as may be desired in a particular given situation. This alternative display configuration may also be desirable when portable display station 100 is to be stabilized by an object placed upon a partially fanned out base 120. In illustrative examples, a user may insert base 120 under a mattress or couch cushion to facilitate hands-free device use while in bed or a couch; or, where there may be insufficient space to fan out outriggers 121, 123, 125 to the extent desired, a user may place a book or other weighted object upon a partially fanned out base 120 to improve stability.

As shown in FIGS. 2A-2D, in some embodiments, all but the bottom outrigger 125 may include one or more protrusions to improve the stability of base 120 when it is, for example, placed on a flat surface. Specifically, such protrusions may serve to prevent wobbling due to the variance in respective vertical positions of the outriggers. For example, upper outrigger 121 may include a protrusion 122 at the end of opposite from pivot recess 129 and middle outrigger 123 may include a protrusion 124 at the end of opposite from pivot recess 129. With reference to FIGS. 2A and 2B, the inclusion of protrusion 124 may be accommodated by bottom outrigger 125 having a shorter length than middle outrigger 123 by at least the corresponding dimension of protrusion 124. Similarly, the inclusion of protrusion 124 may be accommodated by middle outrigger 123 having a shorter length than upper outrigger 121 by at least the corresponding dimension of protrusion 122. In this manner, the outriggers may be considered nested together when they are stacked in a collapsed configuration.

FIGS. 3A-3C depict a base 120 embodiment similar to that of FIGS. 2A-2D, but where protrusions are positioned on the sides of respective outriggers rather at their ends. As shown, upper outrigger 121 may include a protrusion 122 on a first side and middle outrigger 123 may include a protrusion 124 on the opposite side. As can be appreciated from FIG. 3A, bottom outrigger 125 may have a surface area smaller than middle outrigger 123 to accommodate protrusions 122 and 124, and middle outrigger 123 may have a surface area smaller than upper outrigger 121 to accommodate protrusions 122. In this manner, the outriggers are may be considered nested together when they are stacked in the collapsed configuration. In some embodiments, base 120 may include a combination of both the end protrusions of the embodiment of FIGS. 2A-2D, and the side protrusions of the embodiment of FIGS. 3A-3C.

Outriggers 121, 123, 125 need not be a rectangular shape, as shown, for example in FIGS. 2A-3C, but such shape may be desirable to minimize the footprint of base 120 when in a collapsed configuration. Rounded corners may be desired to prevent the outriggers from damaging objects, such as cushions, or snagging on clothing or other objects.

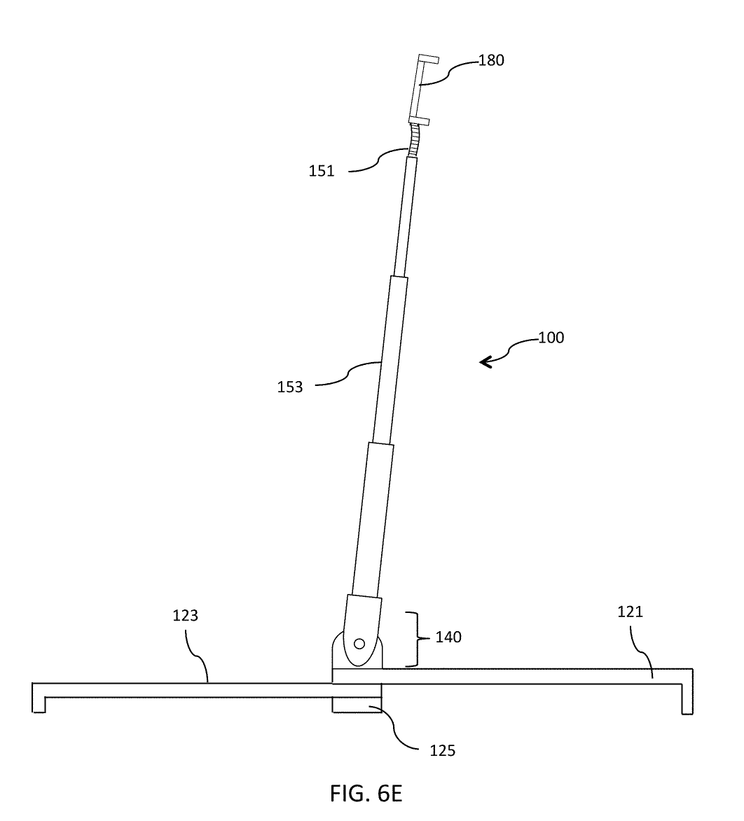

FIGS. 7A-7C depict a base 120 embodiment similar to that of FIGS. 2A-2D, but where the outriggers 121, 123, 125 are petal shaped. FIG. 7A is a top view of base 120 in a display configuration. FIG. 7B is a top view of base 120 in a collapsed configuration. FIG. 7C is a cross-sectional view of base 120 in a collapsed configuration. As described in further detail below, bottom outrigger may include fastener recess 127 to accommodate a fastener—for example, the head of a bolt or pin, or a nut—used to link the outriggers together and, perhaps, link the outriggers to joint assembly 140.

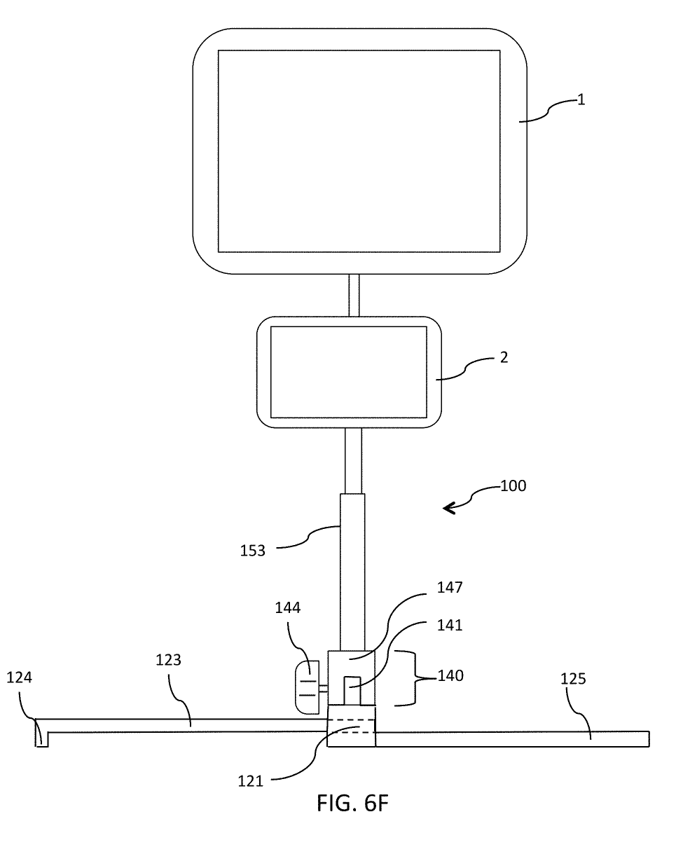

FIGS. 8A and 8B depict a base 120 embodiment similar to that of FIGS. 3A-3C, but where the outriggers 121, 123, 125 are petal shaped. FIG. 7A is a top view of base 120 in a collapsed configuration. FIG. 7B is a top view of base 120 in an alternative display configuration where the outriggers are partially fanned out. A petal shape may be desirable, for example, to improve user comfort in situations where a user sits upon the base 120.

Outriggers may comprise plastic—preferably a strong, lightweight plastic; wood; a composite material; a light metal, such as aluminum; carbon fiber; another material known in the art; and/or a combination thereof. In some embodiments, outriggers may include embedded magnetic elements. Such elements may assist in maintaining base 120 in a collapsed configuration. Additionally or alternatively, such magnetic elements may provide additional stability when portable display station 100 may be placed on magnetic or certain metal surfaces.

Although depicted with three outriggers in multiple figures of this disclosure, base 120 may have two, four, five, or more outriggers in alternative embodiments. In alternative embodiments, one or more outriggers 121, 123, 125 may include one or more hinged elements that serve to further enlarge the footprint 130 of base 120 when unfurled. In alternative embodiments, outriggers may be oval shaped, triangular, or any other suitable shape. In yet other alternative embodiments, base 120 may include a single pad or board suitable to anchor portable display station 100, at least when weighted down by a person or object.

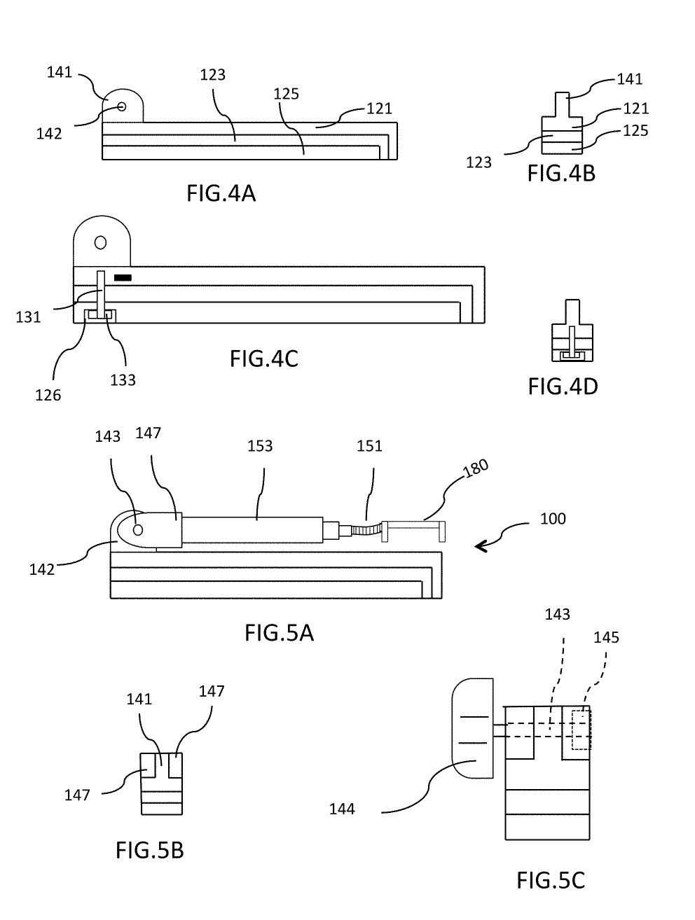

FIGS. 4A-4D depict side, back, cross-sectional side, and cross-sectional back views, respectively, of an embodiment of base 120, wherein base connection element 141 is integrally formed with upper outrigger 121. Base connection element 141 may be considered part of joint assembly 140. Base connection element 141 may include joint recess 142 to receive joint pin 143. As shown in FIGS. 4C and 4D, pivot pin 131 may be be embedded or otherwise included within pivot recess 129 to link outriggers 121, 123, 125 together. In the embodiment shown, a top end of pivot pin 131 may be secured within upper outrigger 121 through any suitable manner known in the art. For example, pivot pin 131 may be secured via glue, compression fit, threads, or by forming outrigger 121 around pivot pin 131. Pivot pin 131 may be a bolt with a head (not shown) secured within upper outrigger 121. The bottom end of pivot pin 131 may include threads 132 (not shown in FIGS. 4C and 4D) configured to receive pivot nut 133 within fastener recess 127. In other embodiments, a pivot pin 131 may be a bolt with a head positioned within fastener recess 127 and its opposite end may be secured within upper outrigger 121 via an embedded nut or any other suitable manner known in the art.

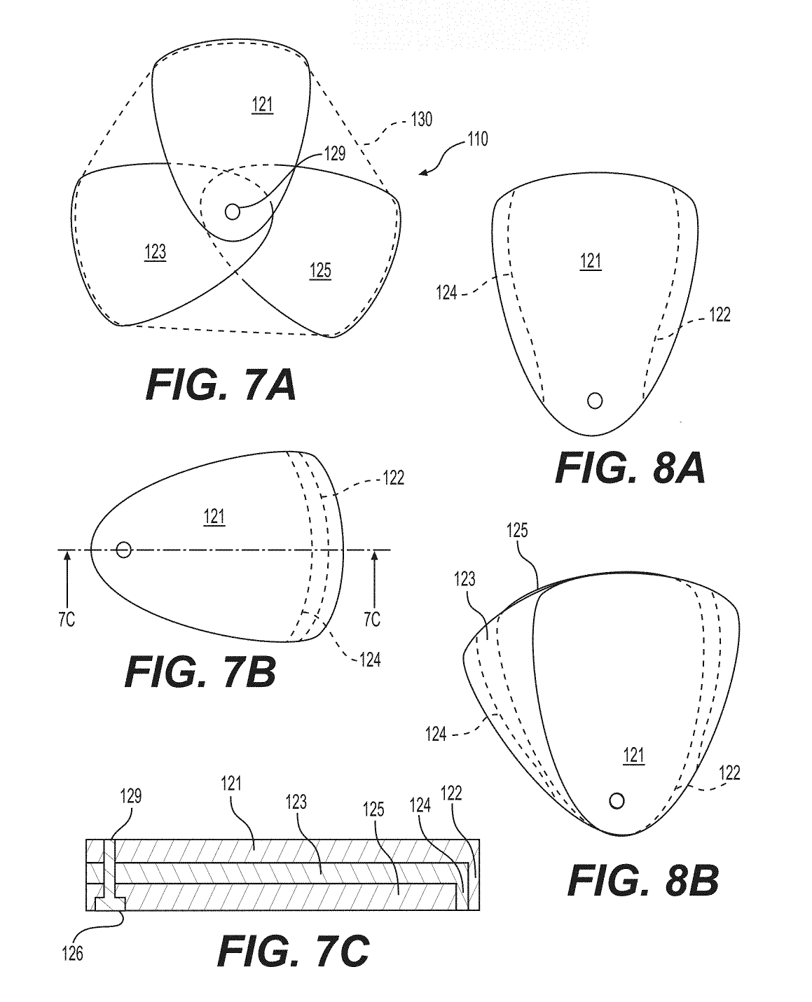

FIGS. 9A-9C depict a combined base connection element 141 and pivot pin 131. As shown in this embodiment, base connection element 141 may be formed separately from upper outrigger 121. In this embodiment, pivot pin 131 may be inserted through pivot recess 129 of base 120. A pivot nut 133 may be engaged on threads 132 of pivot pin 131, for example, within fastener recess 127 of bottom outrigger 125. In this manner, base 120 may be assembled with base connection element 141 securely attached. In some embodiments, base connection element 141 may additionally be glued to, or otherwise further secured to, upper outrigger 121.

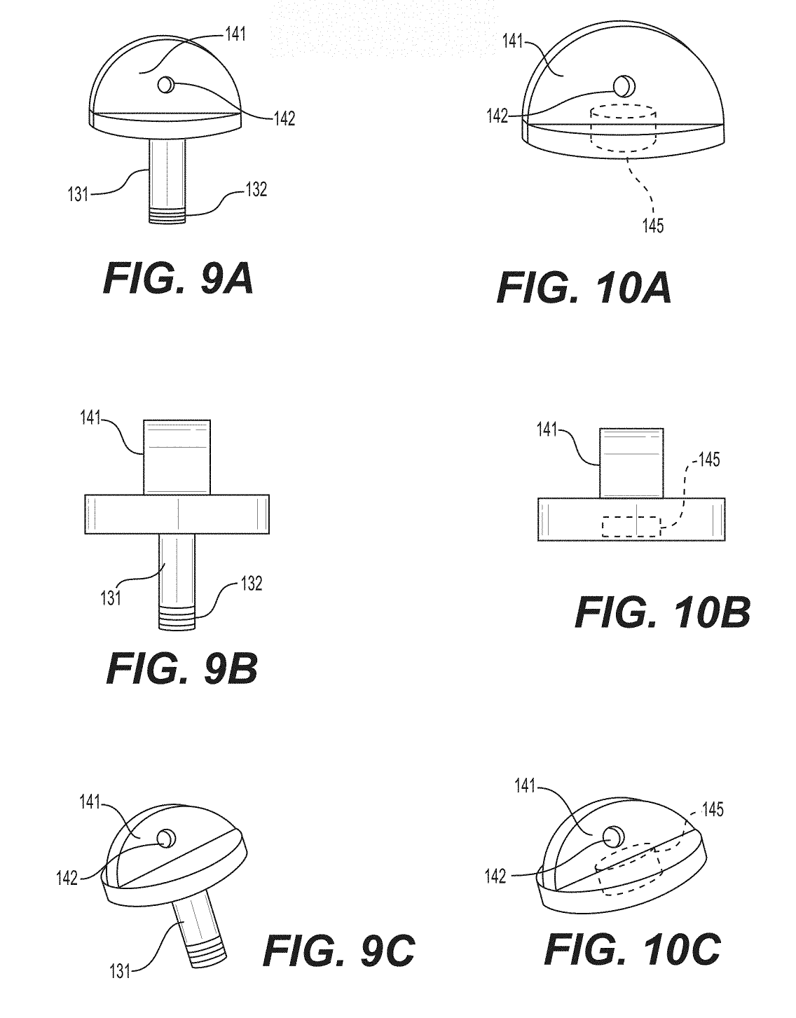

FIGS. 10A-10C depict an embodiment of base connection element 141 that includes base connection nut 145. As an alternative to base connection nut 145, base connection element 141 may configured to receive and secure the end of pivot pin 131, for example, by means of glue, compression fit, threads, or any other means known in the art. In this embodiment, a separate pivot pin 131 may be inserted through pivot recess 129 of base 120 and secured with connection nut 145 or the like. A head of pivot pin 131, for example, may then be positioned within fastener recess 127 of bottom outrigger 125. In this manner, base 120 may be assembled with base connection element 141 securely attached. In some embodiments, base connection element 141 may additionally be glued to, or otherwise further secured to, upper outrigger 121.

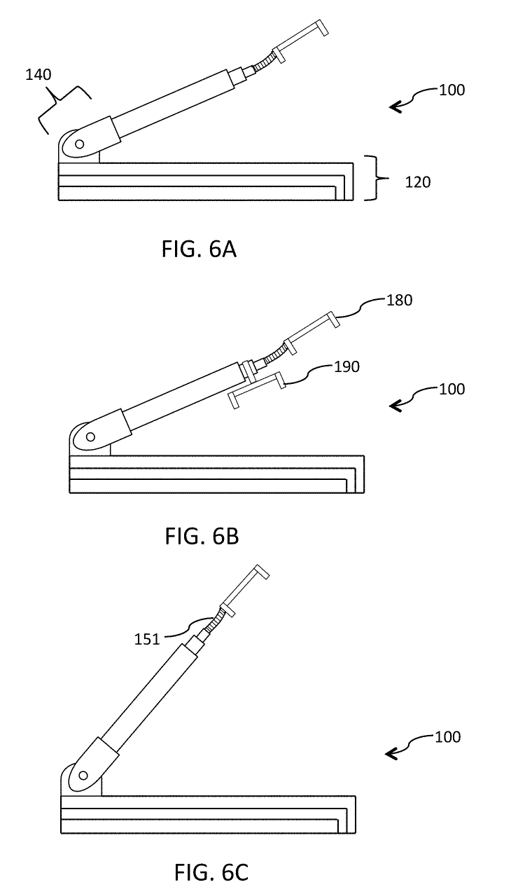

FIGS. 5A and 5B, depict side and back views, respectively, of the base 120 embodiment of FIGS. 4A and 4B, but also include joint assembly 140, arm 150, and main device support 180 to form portable display station 100. As shown in FIGS. 5A and 5B, portable display station 100, including joint assembly 140 and base 120, is in a collapsed configuration. In this collapsed configuration, the orientation of arm 150 may be within five degrees to that of base 120; the components are substantially parallel. Joint assembly 140 may include arm connection element 147, which is secured to the lower portion of arm 150—shown here as telescoping section 153. In some embodiments, arm connection element 147 may substantially surround the lowermost portion of arm 150; it may be further secured to arm 150 via glue, compression fit, threading, nut and bolt, or any other suitable manner known in the art. In yet other embodiments, arm connection element 147 may be integrally formed as part of arm 150. As can be viewed in FIG. 5B, arm connection element 147 may include a forked portion configured to sandwich a corresponding portion of base connection element 141. The respective portions of arm connection element 147 and base connection element 141 may be collectively traversed by joint recess 143, into which joint pin 143 may be inserted. Thus, joint assembly 140 may be a pin joint configured to provide arm 150 a single rotational degree of freedom about joint pin 143.

As shown in FIG. 5C, joint assembly 140 may further comprise joint pin anchor 145 to secure joint pin 143 within joint assembly 140. As shown, joint pin anchor 145 may be a nut with threading that corresponds to that formed on the end of point pin 143. In other embodiments, joint pin anchor 145 may comprise glue, a compression fit mechanism, threading, or any other suitable mechanism known in the art.

Joint assembly 140 may include an adjustable fastener configured to prevent arm 150 movements about the axis of joint pin 143. For example, joint pin 143 may be a wing bolt that includes a handle 144 such that joint assembly 140 may be effectively locked when it is fully tightened and support arm 150 may be rotatable about joint pin 143 when it is loosened.

In alternative embodiments, base connection element 141 may include a forked portion configured to sandwich a single corresponding portion of arm connection element 147. In yet other embodiments, both base connection element 141 and arm connection element 147, respectively, may include multiple interleaved portions traversed by joint recess 142 to form a more robust joint.

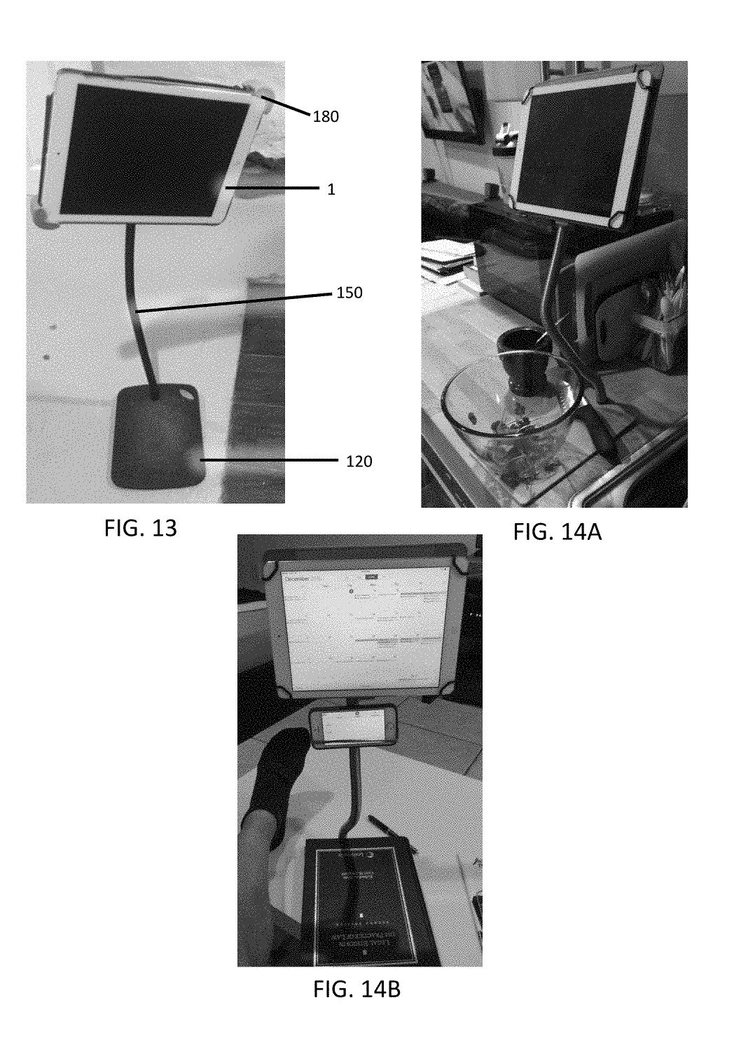

In some embodiments, base 120 may not comprise multiple outriggers. For example, as shown in FIG. 13, base 120 may comprise a unitary element. As with outriggers discussed above, a base 120 may comprise plastic—preferably a strong, lightweight plastic; wood; a composite material; a light metal, such as aluminum; carbon fiber; another material known in the art; and/or a combination thereof. In some embodiments, base 120 may include embedded magnetic elements to assist in maintaining base 120 in a collapsed configuration. Additionally or alternatively, such magnetic elements may provide additional stability when portable display station 100 may be placed on magnetic or certain metal surfaces. In yet other embodiments, base 120 may not comprise outriggers, but may include one or more hinged elements that serve to further enlarge the footprint 130 of base 120 when unfurled.

Regardless of the structure of base 120, the stability of portable display station 100 during use may be advantageously improved by positioning some or all of base 120 under a weighted object. Placing a weighted object upon base 120 reduces the likelihood that portable display station 100 may fall over, potentially causing damage to any attached display devices. Further, stabilizing portable display station 100 in this manner may advantageously permit use in configurations that wherein the center of gravity of portable display station 100 and any attached displays would be outside of the footprint of base 120.

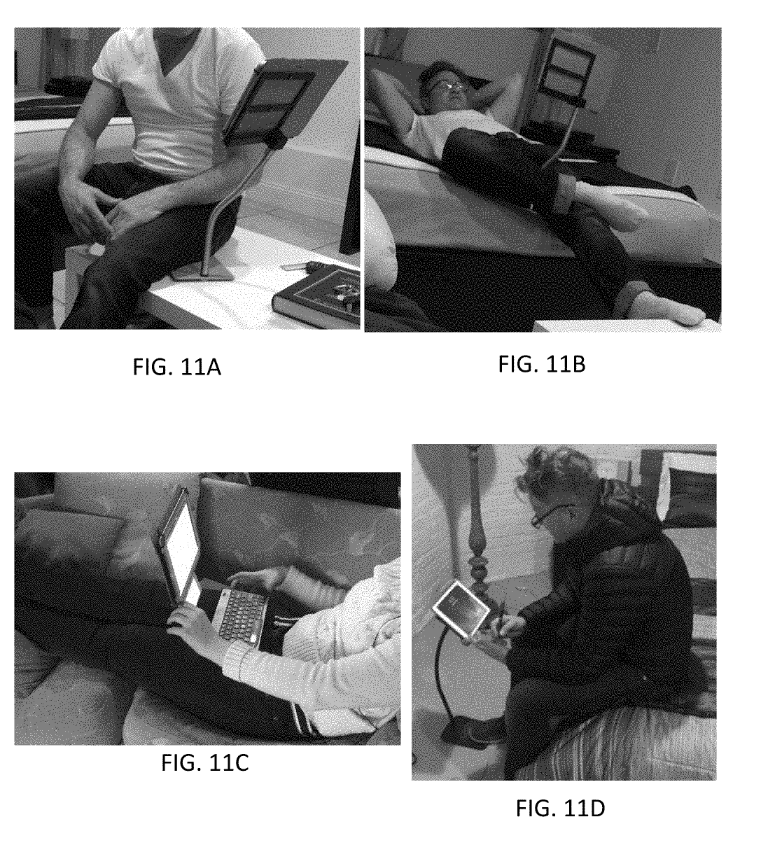

The weighted object may be, for example, a person's body or an inanimate object. For example, as show in FIG. 11A, a user may stabilize portable display station 100 by sitting on base 120 with articulating arm 150 to the outside of his legs. This may be useful when a user is on public transport (such as, for example, a bus or a train), while waiting on a bench, or in similar situations. Alternatively, as shown in FIGS. 11B and 11C, a user may stabilize portable display station 100 by sitting on base 120 with articulating arm 150 between his or her legs, when sitting, reclining, or lying down. This may be useful, for example, when a user is in a bed, on a couch, on a recliner, or seated in business class on an airplane. Further, as shown in FIG. 11D, a user may stabilize portable display station 100 by placing his foot, knee, or other body part upon the base 120.

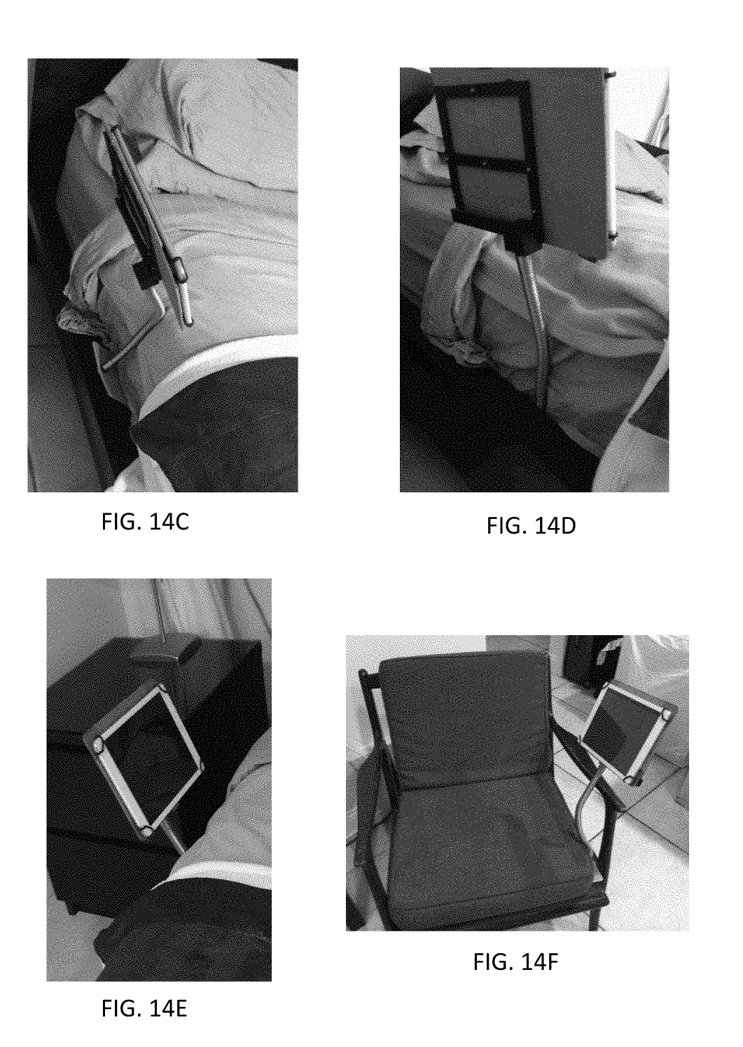

As shown in FIGS. 14A and 14B, a user may stabilize portable display station 100 by placing a weighted object upon base 100, such as a bowl or a book. As shown in FIGS. 14C-14E, portable display station 100 may be stabilized by placing base 120 under a mattress; an attached display device can then be used hands-free in bed. Similarly, as shown in FIG. 14F, portable display station 100 may be further stabilized by placing base 120 under a cushion, for example when used in a chair; an attached display device can then be used hands-free in the chair.

In some embodiments, joint assembly 140 may be configured to permit rotation at specific increments. That is, portable display station 100 may be configured to be locked into a configuration only when arm 150 is at particular angles with respect to base 130. This may be accomplished, for example through interlocking radial ribbing along the sides of corresponding adjacent portions of base connection element 141 and arm connection element 147. The inclusion of such radial ribbing may, for example, advantageously serve to prevent undesired rotation of arm 150 when it is locked in a particular configuration.

Arm 150 may include a telescoping section 153, which may be advantageously fully or partially expanded in display configurations and may be retracted in a collapsed configuration. That is, inclusion of one or more telescoping sections 153 may facilitate storage and mobility of the device in a collapsed configuration, while allowing greater arm 150 length while in use. Telescoping section 153 may be included in a lower portion of arm 150 and may be engaged with joint assembly 140 via arm connection element 147.

An upper portion of arm 150 may include an adjustment element that permits an orientation of main device support 180 to be modifiable relative to the position of support arm 150. For example, the adjustment element of arm 150 may be gooseneck section 151. Gooseneck section 151 may offer a high degree of manipulation for positioning the main device support 180, and consequently primary display device 1, as a user may desire. As would be understood by a person of skill in the art, a gooseneck section should be rigid enough to support the weight of a primary display device 1 or other with negligible movement, but should have limited resistance such that a user may easily manipulate main device support to a desired angle and position. In certain embodiments, gooseneck sections may comprise bendable aluminum alloys, which are relatively cheap and lightweight, such as aluminum-magnesium alloys. Further, in some embodiments, a more rigid gooseneck section surrounding an internal bendable aluminum alloy rod may be used; the rod may be constructed from a reduced-magnesium aluminum alloy. While gooseneck section 151 may potentially present some problems associated with gooseneck-type prior art devices, such problems may be mitigated by including a shorter gooseneck section 151, for example, less than five inches, less than four inches, less than three inches, or less than two inches. Moreover, because the gooseneck section 151 need not necessarily be bent each time a user modifies the configuration of portable display station 100—and would rarely need to be be substantially reconfigured, as may be required by, for example, “The Flexible Stand Up Cable”—a rigid gooseneck section 151 may be used.

Additionally, or alternatively, the adjustment element may comprise a ball and socket joint connecting the main device support 180 to support arm 150.

In some embodiments, for example, as shown in FIG. 1B, portable display station 100 may include one or more arm joints 170. As shown, multiple telescoping sections 153 may be connected via one or more arm joints 170. Inclusion of one or more arm joints 175 may permit a plurality of sections of arm 150 to fold against each other in a collapsed configuration. In this manner, the maximum height of arm 150 may be substantially increased without significantly increasing of the dimensions of portable display station 100 when it is in a collapsed configuration. Arm joint 170 may be similar to joint assembly 140.

Arm joint 170 may, for example, be configured to lock at approximately 0 degrees (for storage), at approximately 180 degrees (straight up and down), or at a variety of intermediate angles to facilitate display at a desired height and angle, such as, for example 30 degrees, 45 degrees, 60 degrees, 90 degrees, 120 degrees, 135 degrees, and/or 150 degrees. Arm joint 175 may have one degree of freedom in some embodiments to facilitate cheaper manufacture and lighter weight of portable display station 100. In other embodiments, arm joint 175 can articulate in a second and/or third additional degree of freedom, and/or may rotate about its axis. For example, arm joint 170 may be a lockable ball and socket joint.

In alternative embodiments, support arm 150 may also include rod sections, which may be non-telescoping rods comprising plastic, metal, wood or a composite material. Such rods may be solid, hollow, or a combination thereof.

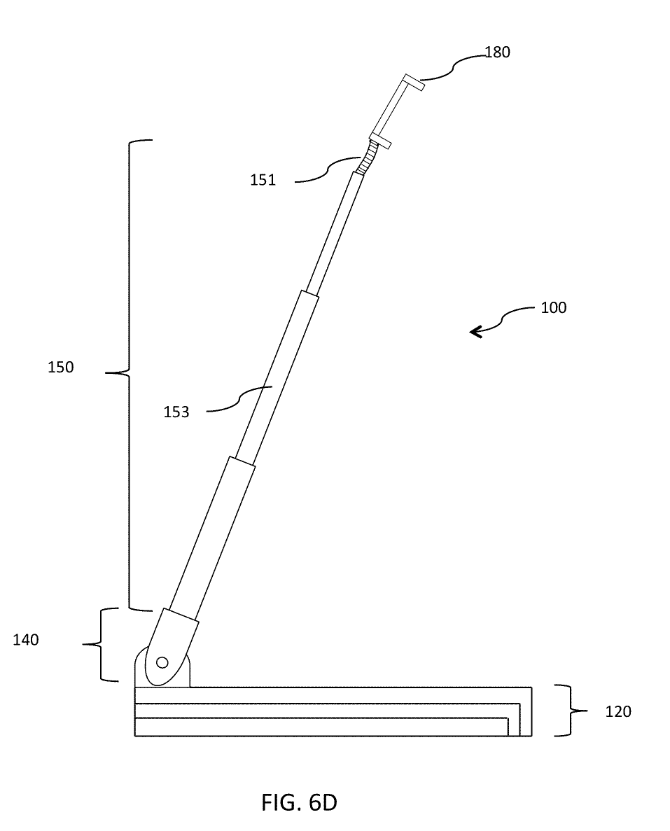

Main device support 180 may removably secure primary display device 1, which may be, for example, tablet (as shown in FIG. 6F), or a smart phone (as shown in FIG. 1A). Main device support 180 may secure device 1 by, for example, grasping one or more sides or corners of the display device via spring based-clamps, screw-based clamps, clips, elastic bands, or any other type of securing mechanism known in the art. For example, FIG. 1A depicts main device support 180 as a clamp that grasps the top and bottom of an iPhone. As another example, FIG. 1B depicts main device support 180 as a flat surface with elastic bands 181 to grasp corners of a tablet. In other embodiments, main device support 180 may secure device 1 via an adhesive gel, preferably one that does not leave residue when removed, like that of the “Gekko Stand”; via one or more magnets; or via any other suitable method of temporary or permanent attachment.

In alternative embodiments, main device support 180 may be configured to secure laptop computers, other types of mobile devices, cameras, or even non-electronic devices such as books, magazines, papers, or beverages—for example, in a cupholder embodiment. In yet other embodiments, main device support 180 may be configured to hold multiple devices, for example, two tablets, a tablet and a camera, or other combinations of objects and display devices discussed above.

As noted above, the upper end of arm 150 may connect to main device support 180. In some embodiments, the upper end of arm 150 may be fused, glued, welded, or otherwise permanently attached to the main device support 180. However, in other embodiments, main device support 180 may be readily detachable such that a user may elect to switch the type of main device support 180 used. In such embodiments, arm 150 and main device support 180 may be attachable and detachable via threads or any suitable mechanism known in the art. For example, in various instances, a user may want to support a tablet, a smart phone, a book, or a beverage, and modify portable display station 100 accordingly.

In some embodiments, main device support 180 may be configured to allow a supported electronic display to rotate in, for example 90 degree increments, 45 degree increments, or any other desired increments. This may advantageously allow a user to view displayed media in portrait, landscape, or other orientation, as appropriate. In some embodiments, main device support 180 may be partially collapsible when not in use; for example, segments of main device support 180 may be configured to slide into one another. In other embodiments, main device support 180 may be folded, for example, in half, in thirds, in quarters, or the like, when not in use.

As shown in FIGS. 6B and 6F, portable display station 100 may further include one or more secondary device supports 190, which may be configured in any way known in the art, as discussed above with respect to main device support 180. FIG. 6F depicts an example of a portable display station 100 with an iPad positioned in main device support 180 and an iPhone positioned in secondary device support 190. FIG. 6B depicts a similar example wherein secondary device support 190 is depicted attached to support arm 150. In other embodiments, secondary device support 190 may be configured to hold and display papers. A secondary device support 190 to hold papers may comprise a clipboard, clips, a plastic board, and/or elastic bands. In other embodiments, secondary device supports 190 may be configured to hold other commonly used items, for example, writing utensils, beverages, eye glasses, keys, cooking utensils or spices for cooking, keyboards, laser pointers, and other electronic and non-electronic instruments and devices.

FIGS. 6A and 6C illustrate the portable display station 100 embodiment of FIG. 5A after arm 150 has been partially raised by rotating it about joint assembly 140. FIG. 6B is similar to FIG. 6A, but further includes secondary device support 190, which is attached to arm 150. In FIG. 6D, arm 150 is further raised, with respect to FIG. 6C, and telescoping section 153 has been expanded to increase the display height of portable display station 100. In FIG. 6E, arm 150 is further raised, with respect to to FIG. 6D, and base 120 is fanned out to provide stability.

FIG. 6F is similar to FIG. 6E, but depicts joint assembly 140 from a front view; includes handle 144; depicts secondary display device 2, which is supported by secondary device support 190 (obscured); and depicts primary display device 1, which is supported by main device support 180 (obscured).

In exemplary embodiments, arm 150 may be different lengths, for example, in the ranges of 10-14 inches, 14-20 inches, 20-24 inches, 24-28, inches, 28-32 inches, or 32-36 inches, when in use. In yet other embodiments, a longer arm, for example in the ranges of 38-50 inches or 50-62 inches, while in use, may permit portable display station 100 to be used as a portable podium.

In some embodiments, portable display station 100 may include one or more batteries configured to supply power to supported device. One or more batteries may be included in base 120. In such embodiments, any additional weight from the battery may further anchor the display station. Preferably, the batteries would be rechargeable and base 120—or alternatively other components of the portable display station 100—may include a standardized port, for example a USB port, to receive power from an external source. An LED or other light or display may be included to indicate the strength of the charge in the base 120.

Charging wires may run from the batter(ies) in base 120 and through the articulating arm to supply power to the main device support 180—and, in some embodiments, to one or more secondary device supports 190. Such charging wires may be run through hollow centers of gooseneck sections, telescoping sections, and rods. Where telescoping sections are included, at least a portion of the charging wires may be coiled to accommodate the range of permissible arm 150 lengths. Joints may be selected or designed to permit wires to run through them without being pinched or damaged during articulation. Charging wires may terminate at the support(s) 180 (and 190) with common standardized connectors, such as USB, firewire, or the like, and/or may supply conductive wireless charging of electronic devices at the support(s) 180 (and 190).

One or more of the outriggers may include a thin battery, such as, for example, battery types currently used in mobile phones. Pivot recess 129 may be fitted with a rotating electrical connector that connects each of the batteries to one another and the charging wires in parallel. For example, the rotating electrical connector may comprise one or more slip rings and may be integrated into the base connection element 141.

In another embodiment, one or more batteries, for example standardized rechargeable batteries such as 18650. Li-ion cells, may be included on or within upper outrigger 121. For example, the batteries may be aligned along the lengthwise dimension of outrigger 121 such that, when portable display station 100 is in a collapsed configuration, the batteries may be positioned between arm 150 and the remainder of base 120. In this manner, inclusion of batteries may not substantially increase the dimensions of portable display station 100 when in a collapsed configuration.

In yet other embodiments, portable display station may include one or more solar panels to charge supported devices and/or included batteries. The base 120 may comprise one or more solar panels.

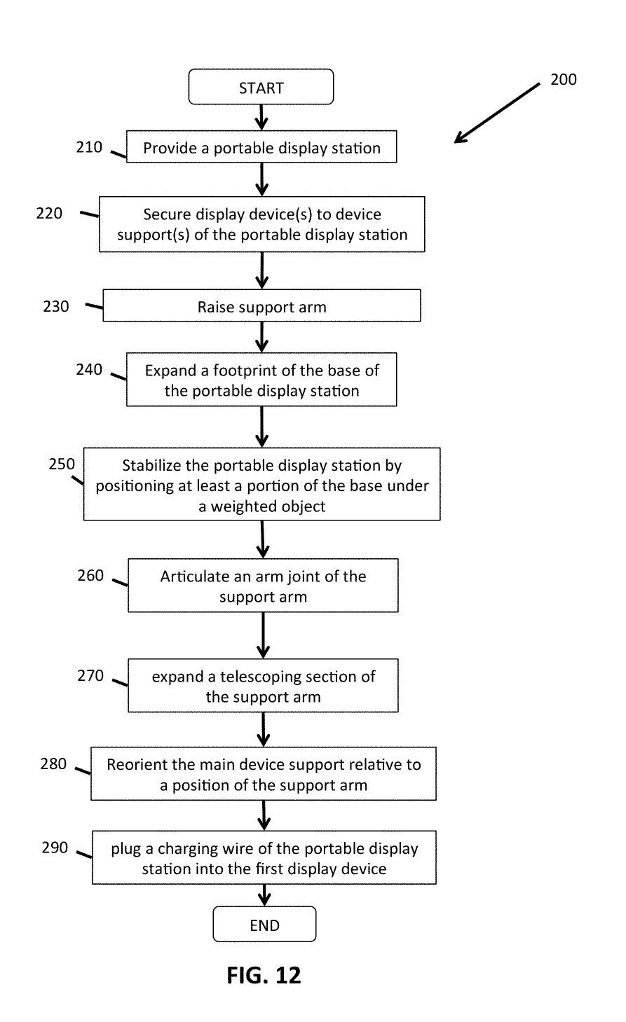

FIG. 12 illustrates exemplary method 200 for using portable display device 100. As would be apparent to persons of skill in the art, the exact order of certain steps of method 200 may be altered in various embodiments, consistent with the principles of this disclosure. Similarly, certain steps of method 200 may be substituted, combined, or removed in various embodiments—consistent with the disclosure herein and/or as would be apparent to persons of skill in the art.

As in step 210, an embodiment of portable display station 100 may be provided.

As is step 220, a user may secure primary display device 1 to main device support 180, for example as shown in FIG. 13. Additionally or alternatively, as in step 220, a user may secure secondary display device 2 to secondary device support 190.

As is step 230, a user may at least partially raise support arm 150, for example, as depicted in FIGS. 5A, 6A, 6C, and 6D. In some embodiments, a user may raise support arm 150 by articulating joint assembly 140. In other embodiments, for example, where support arm 150 is fastened to base 120 such that the elements do not move with respect to each other, for example, as shown in FIG. 13, step 230 may be skipped.

As is step 240, a user may expand a footprint 130 of base 120 when applicable. For example, as shown in FIG. 2D, a user may partially fan out one or more outriggers. Additionally or alternatively, a user may unfurl hinged elements of base 120. In other embodiments, for example, as shown in FIG. 13, where base 120 is a unitary element, step 240 may be skipped.

As is step 250, a user may stabilize portable display station 100 by positioning at least a portion of the base under a weighted object. The weighted objected may be, for example, a user's body or an inanimate object. For example, a user may place a body part on at least a portion of base 120. In some embodiments, a user may sit on at least a portion of the base with support arm 150 positioned either between or outside of his or her legs. In other examples, a user may place a mattress, a cushion, or a book upon at least a portion of base 120.

As in step 260, if support arm 150 has one or more arm joints 170, the user may articulate one or more arm joints 170 as desired to position and orient the display device(s).

As in step 270, if support arm 150 has one or more telescoping sections 153, the user may extend one or more telescoping sections 153 as desired to position and orient the display device(s).

As in step 280, if support arm 150 has an adjustment element that permits an orientation of main device support 180 to be modifiable relative to the position of support arm 150, a user may use the adjustment element to reorient the main device support relative to a position of the support arm. For example, if the adjustment element is a gooseneck section 151, the user may manipulate gooseneck section 151 as desired to position and orient the display device(s).

As in step 290, if portable display station has one or more charging wires 175, the user may plug one or more charging wires of the portable display station into the first display device.

After an embodiment of method 200 is completed, the portable display station 100 may be in a desirable position for the user to utilize the display device(s).

Although the foregoing embodiments have been described in detail by way of illustration and example for purposes of clarity of understanding, it will be readily apparent to those of ordinary skill in the art in light of the description herein that certain changes and modifications may be made thereto without departing from the spirit or scope of the appended claims. It is also to be understood that the terminology used herein is for the purpose of describing particular aspects only, and is not intended to be limiting, since the scope of the present invention will be limited only by the appended claims.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or use of a “negative” limitation. As will be apparent to those of ordinary skill in the art upon reading this disclosure, each of the individual aspects described and illustrated herein has discrete components and features which may be readily separated from or combined with the features of any of the other several aspects without departing from the scope or spirit of the disclosure. Any recited method can be carried out in the order of events recited or in any other order that is logically possible. Accordingly, the preceding merely provides illustrative examples. It will be appreciated that those of ordinary skill in the art will be able to devise various arrangements which, although not explicitly described or shown herein, embody the principles of the disclosure and are included within its spirit and scope.

Furthermore, all examples and conditional language recited herein are principally intended to aid the reader in understanding the principles of the invention and the concepts contributed by the inventors to furthering the art, and are to be construed without limitation to such specifically recited examples and conditions. Moreover, all statements herein reciting principles and aspects of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary configurations shown and described herein.

In this specification, various preferred embodiments have been described with reference to the accompanying drawings. It will be apparent, however, that various other modifications and changes may be made thereto and additional embodiments may be implemented without departing from the broader scope of the claims that follow. The specification and drawings are accordingly to be regarded in an illustrative rather than restrictive sense.

We claim:

1. A method for using a portable display station, comprising:
providing the portable display station, the portable display station including at least a main device support, a support arm connected to the main device support, and a base connected to the support arm;
securing a first display device to the main device support; and
stabilizing the portable display station,
wherein:
stabilizing the portable display station further comprises positioning at least a portion of the base under a weighted object.

2. The method of claim 1, wherein the first display device is a tablet.

3. The method of claim 1, wherein the first display device is a smart phone.

4. The method of claim 1, further comprising:
securing a second display device to a secondary device support of the portable display station.

5. The method of claim 5, wherein the second display device is a smart phone.

6. The method of claim 1, wherein positioning at least a portion of the base under a weighted object further comprises:
placing a user's body part on at least a portion of the base.

7. The method of claim 1, wherein positioning at least a portion of the base under a weighted object further comprises:
sitting on at least a portion of the base with the support arm positioned between a user's legs.

8. The method of claim 1, wherein positioning at least a portion of the base under a weighted object further comprises:
sitting on at least a portion of the base with the support arm positioned outside of a user's legs.

9. The method of claim 1, wherein positioning at least a portion of the base under a weighted object further comprises:
placing at least part of the base under an inanimate object.

10. The method of claim 1, wherein stabilizing the portable display station further comprises:
expanding a footprint of the base by at least partially fanning out a plurality of outriggers of the base.

11. The method of claim 10, wherein expanding a footprint of the base by at least partially fanning out a plurality of outriggers of the base further comprises:
pivoting a first outrigger of the plurality of outriggers about a first axis.

12. The method of claim 7, wherein stabilizing the portable display station further comprises:
expanding a footprint of the base by at least partially fanning out a plurality of outriggers of the base.

13. The method of claim 8, wherein stabilizing the portable display station further comprises:
expanding a footprint of the base by at least partially fanning out a plurality of outriggers of the base.

14. The method of claim 1, further comprising:
raising the support arm.

15. The method of claim 14, where raising the support arm further comprises:
articulating a joint assembly of the portable display station, the joint assembly connecting the support arm and the base.

16. The method of claim 1, further comprising:
reorienting the main device support relative to a position of the support arm.

17. The method of claim 1, further comprising:
articulating an arm joint of the support arm.

18. The method of claim 1, further comprising:
expanding a telescoping section of the support arm of the portable display device.

19. The method of claim 1, further comprising:
manipulating a gooseneck section of the support arm.

20. The method of claim 1, further comprising:
plugging a charging wire of the portable display station.
